(19) United States
(12) Patent Application Publication
(10) Pub. No.: US 2023/0172093 A1
(43) Pub. Date: Jun. 8, 2023

(54) COMPOSTING DEVICE AND METHOD

(71) Applicant: Tarim University, Alar (CN)

(72) Inventors: Ling ZHOU, Alar (CN); Xuehan FU, Alar (CN); Xiaojun GUO, Alar (CN); Long LIU, Alar (CN); Longjie WANG, Alar (CN); Qiao FU, Alar (CN)

(73) Assignee: Tarim University, Alar (CN)

(21) Appl. No.: 18/070,501

(22) Filed: Nov. 29, 2022

(30) Foreign Application Priority Data
Dec. 2, 2021 (CN) 202111461798.6

(51) Int. Cl. A01C 3/02

(52) U.S. Cl. CPC A01C 3/026; A01C 3/023

(57) ABSTRACT

A composting device includes a stirring device, a conveyor belt and a decomposing device. The stirring device, the conveyor belt and the decomposing device are connected successively. A composting method is further provided. An efficient device that can mix livestock and poultry manure, straws and additives fully and uniformly is researched and developed, a conventional method is broken, new innovation is achieved, and the efficiency is improved.

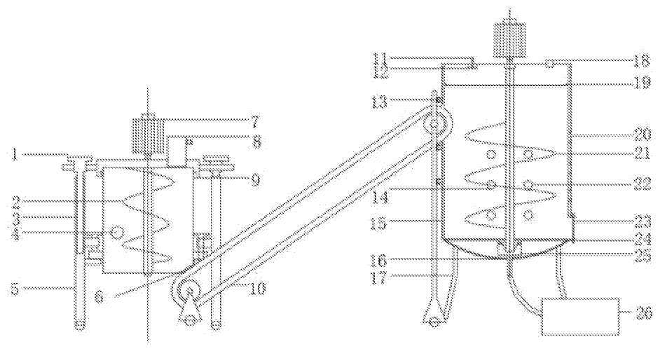

### CROSS REFERENCE TO THE RELATED APPLICATIONS

This application is based upon and claims priority to Chinese Patent Application No. 202111461798.6, filed on Dec. 2, 2021, the entire contents of which are incorporated herein by reference.

### TECHNICAL FIELD

The present invention belongs to the technical field of composting, and relates to a composting device and method.

### BACKGROUND

In a process of researching composting of livestock and poultry manure, the inventor found that there was no pre-treatment stirring device in a conventional composting process, and materials were uniformly mixed manually and put in a reaction tank. As the sensor is too long in the conventional reaction tank, it is incompatible with a stirring device. In addition, an oxygen concentration is controlled manually for the conventional reaction tank, so the entire process is tedious, unsmooth in physiological reaction, nonsystematic and low in efficiency. Moreover, the expected effect is not achieved when the treated materials are mixed.

### SUMMARY

In order to overcome deficiencies in the prior art, the present invention provides a composting device and method.

In order to achieve the above-mentioned objective, the present invention adopts the following technical solution:

a composting device includes a stirring device, a conveyor belt and a decomposing device which are connected successively, wherein the stirring device includes a support and a cylinder block which are fixedly connected, a spiral stirring mechanism and a humidity sensor are arranged in the cylinder block, the spiral stirring mechanism is connected to a motor, a liquid feeding device communicated with the cylinder block is arranged on the cylinder block, a first discharge port is formed at a lower portion of the cylinder block, and the first discharge port is formed at one end of the conveyor belt;

the decomposing device includes a reaction tank and a fixed support which are fixedly connected, a stirring mechanism, an oxygen content sensor and a temperature sensor are arranged in the reaction tank, the stirring mechanism is connected to the motor, a water filling port and an eluting device are arranged at an upper portion of the reaction tank, a water draining port and a second discharge port are formed at a lower portion of the reaction tank, the reaction tank is communicated with an aeration system through an oxygen supply port, and a feeding port of the reaction tank is formed at one end of the conveyor belt.

As a preferred mode, a gas release port and a gas concentration sensor are further arranged at the upper portion of the reaction tank, and the temperature sensor is an attached temperature sensor.

As a preferred mode, a positioning block is arranged at the feeding port of the reaction tank.

As a preferred mode, a filter screen and a sampling port are arranged in the reaction tank.

As a preferred mode, the reaction tank is a double-wall tank bodies with an interlayer being made from a polyurethane insulation material.

The present invention further discloses a composting method, including the following steps:

A. putting to-be-treated livestock and poultry manure and crushed straws in a cylinder block of a stirring device, covering a stirring mechanism with a lid, starting a spiral stirring mechanism driven by a motor, adding quantitative wood vinegar and enough distilled water through a liquid feeding device, and stopping water injection when a humidity sensor detects that a water content of the materials reaches 60%, and keeping stirring until the mixture is uniform;

B. delivering the materials in step A to a reaction tank via a conveyor belt through a discharge port, keeping an oxygen concentration at not lower than 2.0% vol, and stirring the mixture by a stirring mechanism until the materials are decomposed; and

C. injecting a heavy metal eluent through a water filling port, eluting passivated heavy metals out by rotation of an eluting device, eluting the mixture, leaving the mixture still and turning the mixture out through the discharge port to complete composting.

As a preferred mode, in step B, an aeration system provides oxygen via an oxygen supply port, and a gas release port is opened to release excess gases when a gas concentration sensor detects the excess gases.

As a preferred mode, in step B, it is judged that the materials are decomposed in the case that the mixture is stirred for more than 30 days, the temperature sensor detects that the temperature of the mixture is over 50° C. for more than 5 days and it is detected that the pH value of a sample taken out from a sampling port is 8.0-9.0 and C/N is smaller than 20.

As a preferred mode, in step C, wastewater generated by eluting heavy metals is controlled by the filter screen to be collected at the water draining port at the bottom of the reaction tank for subsequent treatment.

As a preferred mode, in step A, a mass ratio of the added wood vinegar to the to-be-treated livestock and poultry manure is (0-0.65):100.

The present invention has the beneficial advantages:

1. The device of the present invention is reasonable in structure, stable in performance, simple and easy to operate; materials can be mixed uniformly, the efficiency is improved, a good expected effect is achieved, and the compost decomposing period is shortened greatly; the device can be used for large-scale composting.

2. According to the device, a lot of heavy metals can be removed well, so that secondary hazards of the compost subjected to passivation in soil is greatly reduced.

3. According to the device, oxygen deficiency and water shortage conditions can be detected automatically, aeration and water supplement can be realized automatically, and gas detection and automatic emission functions are achieved.

### BRIEF DESCRIPTION OF THE DRAWINGS

Figure is a structural view of a device of the present invention.

In the figures, 1-handle; 2-spiral stirring mechanism; 3-lead screw; 4-humidity sensor; 5-support; 6-first discharge port; 7-motor; 8-liquid feeding device; 9-cylinder block; 10-conveyor belt; 11-exhaust port; 12-gas concentration sensor; 13-positioning block; 14-oxygen content sensor; 15-reaction tank; 16-water draining port; 17-fixed support; 18-water filling port; 19-eluting device; 20-temperature sensor; 21-spiral stirring mechanism; 22-sampling port; 23-discharge hoe; 24-filter screen; 25-oxygen supply port; 26-aeration system.

### DETAILED DESCRIPTION OF THE EMBODIMENTS

The present invention will be described in detail in combination with the accompanying drawings.

In order to make objectives, technical solutions and advantages of the prevent invention clearer, the prevent invention will be further described below in detail in combination with the accompanying drawings and embodiments. It should be understood that the specific embodiments described herein are only used for explaining the prevent invention, rather than limiting the prevent invention.

### Example

As shown in Figure, a composting device included a stirring device, a conveyor belt and a decomposing device which are connected successively. A handle 1 was rotated and a lead screw 3 was lifted to open a lid of a stirring device, and livestock and poultry manure and straws crushed to be shorter than 10 cm (C/N was adjusted) were directly put in a cylinder block 9. The stirring device was covered with the lid, and a spiral stirring mechanism 2 driven by a motor 7 was started. Quantitative wood vinegar and enough distilled water were poured via a liquid feeding device 8 on the lid to dilute the wood vinegar, and the wood vinegar and the distilled water were dropped into the materials being stirred and mixed through a leak hole below the liquid feeding device. Water injection was stopped when a humidity sensor 4 detected that the water content reached 60%, and then the mixture was stirred for 5 min. After the mixture was uniformly stirred, a discharge port 6 was opened, the spiral stirring mechanism continued to work, the materials were pushed from the discharge port 6 to a conveyor belt 10 (external steel, internally isolated by hard plastic) at a speed of 300 r/min, and the conveyor belt and the reaction tank (double-wall tank, with an interlayer being made from a polyurethane insulation material) were positioned by a positioning block 13. The materials were delivered by the conveyor belt to the reaction tank 15 for decomposition, and oxygen supply was opened from the lower portion of the reaction tank When an oxygen content sensor 14 detected oxygen deficiency, oxygen was supplied for 1 min every 10 min, and meanwhile, a stirring mechanism 21 moved. The oxygen was supplied by an air inlet 25 and an aeration system 26. Generated excess gases were released through a gas release port 11 when a gas concentration sensor 12 detected that the excess gases reached a certain concentration. In order to prevent wastewater from flowing into the port, a half-hiding lid was designed. It was judged that the materials were decomposed in the case that the materials were composted for more than 30 days, a temperature sensor 20 detected that the temperature of the materials was over 500° C. for more than 5 days and it was detected that the pH value of a sample taken out from a sampling port 22 was 8.0-9.0 and C/N was smaller than 20. After the materials were thoroughly decomposed, a heavy metal eluent was injected into an eluting device 19 via a water inlet 18, and the eluting device 19 and a shaft which were connected moved at the same time to elute the passivated heave metals out. Wastewater generated by eluting heavy metals was controlled by a filter screen 24 to be collected at the water draining port 16 at the bottom of the reaction tank 15 for subsequent treatment. The mixture was eluted, left still for 36 h and turned out through the discharge port 23 to complete composting.

The temperature sensor, the humidity sensor, the oxygen content sensor, the gas concentration sensor, the sampling port and the like are arranged on the reaction tank, and a pre-treatment tank and the conveyor belt are movable. When gases are gathered to the upper portion of the tank body at a certain concentration, the gas release port is automatically opened by a control system to release gases When the oxygen concentration in the tank body is too low, the tank body is aerated automatically to realize automatic control.

The present invention is not limited by the above-mentioned specific implementation modes. The present invention is expanded to any new feature or any new combination disclosed in the specification, and steps or any new combination of any new method or process disclosed.

What is claimed is:

1. A composting device, comprising a stirring device, a conveyor belt and a decomposing device, wherein the stirring device, the conveyor belt and the decomposing device are connected successively, wherein
the stirring device comprises a support and a cylinder block, wherein the support and the cylinder block are fixedly connected; a spiral stirring mechanism and a humidity sensor are arranged in the cylinder block, the spiral stirring mechanism is connected to a motor, a liquid feeding device communicated with the cylinder block is arranged on the cylinder block, a first discharge port is formed at a lower portion of the cylinder block, and the first discharge port is arranged at a first end of the conveyor belt;
the decomposing device comprises a reaction tank and a fixed support, wherein the reaction tank and the fixed support are fixedly connected; a stirring mechanism, an oxygen content sensor and a temperature sensor are arranged in the reaction tank, the stirring mechanism is connected to the motor, a water filling port and an eluting device are arranged at an upper portion of the reaction tank, a water draining port and a second discharge port are formed at a lower portion of the reaction tank, the reaction tank is communicated with an aeration system through an oxygen supply port, and a feeding port of the reaction tank is formed at a second end of the conveyor belt.

2. The composting device according to claim 1, wherein a gas release port and a gas concentration sensor are arranged at the upper portion of the reaction tank, and the temperature sensor is an attached temperature sensor.

3. The composting device according to claim 1, wherein a positioning block is arranged at the feeding port of the reaction tank.

4. The composting device according to claim 1, wherein a filter screen and a sampling port are arranged in the reaction tank.

5. The composting device according to claim 1, wherein the reaction tank is a double-wall tank with an interlayer being made from a polyurethane insulation material.

6. A composting method, comprising the following steps:
step A: putting to-be-treated livestock and poultry manure and crushed straws in a cylinder block of a stirring device, covering a stirring mechanism with a lid, starting a spiral stirring mechanism driven by a motor, adding wood vinegar and enough distilled water through a liquid feeding device, and stopping water injection when a humidity sensor detects that a water content of materials reaches 60%, and keeping stirring until a mixture is uniform;
step B: delivering the materials in step A to a reaction tank via a conveyor belt through a discharge port, keeping an oxygen concentration at not lower than 2.0% vol, and stirring the mixture by the stirring mechanism until the materials are decomposed; and
step C: injecting a heavy metal eluent through a water filling port, eluting passivated heavy metals out by rotation of an eluting device, eluting the mixture, leaving the mixture still and turning the mixture out through the discharge port to complete composting.

7. The composting method according to claim 6, wherein in step B, an aeration system provides oxygen via an oxygen supply port, and a gas release port is opened to release excess gases when a gas concentration sensor detects the excess gases.

8. The composting method according to claim 6, wherein in step B, it is judged that the materials are decomposed in a case that the mixture is stirred for more than 30 days, the temperature sensor detects that the temperature of the mixture is over 50° C. for more than 5 days and it is detected that the pH value of a sample taken out from a sampling port is 8.0-9.0 and C/N is smaller than 20.

9. The composting method according to claim 6, wherein in step C, wastewater generated by eluting heavy metals is controlled by a filter screen to be collected at a water draining port at a bottom of the reaction tank for subsequent treatment.

10. The composting method according to claim 6, wherein in step A, a mass ratio of the wood vinegar to the to-be-treated livestock and poultry manure is (0-0.65):100.
